(19) United States
(12) Patent Application Publication
(10) Pub. No.: US 2015/0030807 A1
(43) Pub. Date: Jan. 29, 2015

(54) Crack-resistant Composite Wooden Doors and Their Manufacturing Methods

(71) Applicant: Shili Zou, Qingdao (CN)

(72) Inventor: Shili Zou, Qingdao (CN)

(21) Appl. No.: 14/306,846

(22) Filed: Jun. 17, 2014

(30) Foreign Application Priority Data
Jul. 25, 2013 (CN) 201310317287.6
Apr. 29, 2014 (CN) 201410177338.4

(51) Int. Cl. E06B 3/70

(52) U.S. Cl. CPC E06B 3/7001
USPC 428/137; 49/506

(57) ABSTRACT

The present invention belongs to the technical field of architecture decoration wooden door structure, which includes of a type of crack-resistant composite wooden door and its manufacturing method. It includes the core body, panel plate and core plate. The core body includes core frame and the hollow section which enclosed by the core frame. The core plate is installed in the inside of the hollow section. There is hollowed-out section in the panel plate. The shape of the panel plate matches that of the core body, and the shape of the hollow-out section matches that of the hollow section. A manufacturing method of the crack-resistant composite wooden door is provided accordingly.

### CROSS-REFERENCES TO RELATED APPLICATIONS

The present application claims priority under the Paris Convention to Chinese application CN 201310317287.6 which was filed on Jul. 25, 2013, and Chinese application CN 201410181015.2 which filed on Apr. 29, 2014, the disclosure of which is herewith incorporated by reference in its entirety.

### TECHNICAL FIELD

The present invention belongs to the technical field of architecture decoration wooden door structure, which includes of a kind of crack-resistant composite wooden door and its manufacturing method.

### BACKGROUND OF THE INVENTION

The structure of wooden doors on the market is mostly composed of a frame enclosed by rails and stiles, with core plates and glass panels in the middle, and grooves carved on the rails and stiles. The core plates and glass panels are installed in these grooves and assembled as a whole door. Then the door is paint varnished. However, affected by the variation of room temperatures and humidity during the applying or processing procedures, the wood tends to expand with heat and contract with cold, causing the vanish on the interfaces of the rails and stiles to crack, which is commonly known as crackle paint. The quality and beauty of the wooden door is severely diminished, especially wooden doors with white paint base.

The utility model patent CN 201284605 Y discloses a type of solid wooden doors, which include the frameworks of the doors and the core plates installed in the frames. The frameworks are consisted of right and left stiles, top rails, middle rails and bottom rails. The characteristics of this type of doors are: the core plates, right and left stiles, top rails, middle rails and bottom rails concerned are all of composite wood structures. And the composite woods concerned are all made by putting a frame and two plates together by hot pressing and gluing. The frame is constructed by connecting two stiles and several rails.

The invention model patent CN 103362411 A discloses a type of composite wooden doors, whose characteristics are as follows: It consist of a core structure and two panel plates of the same size and shape as the core structure. The panel plate is an integrated structure including a hollow-out section. The panel plate and the wood panel structure are solidly connected. The core structure consists of an exposed core plate, a securing frame, a door frame and lock wood. The core plate is fastened and installed in the inside of the securing frame, which is secured in the inside of the door frame, enabling the core plate located in the hollow-out section. The lock wood is installed in the gap between the solid frame and the door frame.

### BRIEF SUMMARY OF EMBODIMENTS OF THE INVENTION

In order to solve the prior technical problems, the invention discloses a composite wooden door, which is lighter, with better thermal insulation as well as paint crack-resistant, and it's manufacturing method.

The technical scheme of the invention is as below: a crack-resistant composite wooden door, which includes core body, panel plate and core plate. The core body includes a core frame and a hollow section which enclosed by the core frame. The core plate is installed in the inside of the hollow section. There is hollow-out section in the panel plate. The shape of panel plate matches that of the core body; the shape of the hollow-out section matches that of the hollow section.

The hollow section is a hollow out structure of one or several combined shapes of triangle, rectangle, square and fillet rectangle or circle. Besides the shapes above, the hollow section can also have many other regular and irregular shapes of decorative hollow out structure.

The core frame consists of left stile, right stile, top rail and bottom rail.

Besides the left stile, right stile, top rail and bottom rail, the core frame also consists of other stiles and rails.

The core frame consists of outside frame and inside frame. Inside the hollow structure enclosed by the outside frame and inside frame there is a filling section. The materials put in the filling section are foam material, honeycomb paper, solid wood, shaving board or MDF(medium-density fibreboard). The material used as the outside frame is solid or MDF, and the material for the inside frame is solid or MDF.

A groove was in the inside frame, and the width of which should match the thickness of the core plate installed in the hollow section. The materials of the core plate are MDF, solid wood, glass, PMMA, shaving board, plywood, sandwich panel and other high molecular materials.

On the left stile and/or right stile there should be a lock rail. The lock rail is used to install the locks.

The manufacturing method of the crack-resistant composite wooden door mentioned above includes the following steps:

(1) produce the core frame and insert the core plate in the grooves of the inside core frames;

(2) fasten and install the lock rail in the hollow section of the left stile and/or right stile of the core frame. Then put the filling section into the hollow structure formed by the outside and inside frames of the core frame;

(3) produce the panel plate according to the shape of the core body, leaving a surplus of 1-5 mm respectively at the outside of the panel plate and the inside of its hollow-out section;

(4) fasten and connect the panel plate and the core body, and do the edge milling for the outside edges of the panel plate and the inside edges of the hollow-out section according to the sizes of the core body, so that the panel plate will completely match the core body.

The connecting method of the panel plate and core body are cold pressing cohesion or hot pressing cohesion or gluing.

A crack-resistant composite wooden door, including core body, panel plate, core plate, and outside wooden line. The core body includes a core frame and a hollow section which enclosed by the core frame. The core plates are installed in the hollow section. There are hollow-out sections on the panel plate. The shape of the panel plate should match the shape of the core body, and the shape of the hollow-out section should match that of the hollow section. The outside wooden line is designed along the inside edge of the hollow-out section.

The hollow section is a hollow out structure of one or several combined shapes of triangle, rectangle, square and fillet rectangle or circle. Besides the shapes above, the hollow section can also have many other regular and irregular shapes of decorative hollow out structure.

The core frame consists of left stile, right stile, top rail and bottom rail.

Besides the left stile, right stile, top rail and bottom rail, the core frame also consists of other stiles and/or rails.

The core frame consists of the outside frame and the inside frame. Inside the hollow structure enclosed by the outside frame and the inside frame there is a filling section. The materials put in the filling section are foam material, honeycomb paper, solid wood, shaving board or MDF (medium-density fibreboard). The material used as the outside frame is solid wood or MDF, and the material for the inside frame is solid wood or MDF.

There should be a groove in the inside frame, and the width of which should match the thickness of the core plate installed in the hollow section. The materials of the core plate are MDF, solid wood, glass, PMMA, shaving board, plywood, sandwich panel and other high molecular materials.

On the left stile and/or right stile there is a lock rail, which is used to install the locks.

The manufacturing method of the above crack-resistant composite wooden door includes the following steps:

(1) produce the core frame and insert the core plate in the grooves of the inside core frames;

(2) fasten and install the lock rail in the hollow section of the left stile and/or right stile of the core frame. Then put the filling section into the hollow structure formed by the outside and inside frames of the core frame;

(3) produce the panel plate according to the shape of the core body, leaving a surplus of 1-5 mm respectively at the outside of the panel plate and the inside of its hollow-out section;

(4) fasten and connect the panel plate and the core body, and do the edge milling for the outside edges of the panel plate and the inside edges of the hollow-out section according to the sizes of the core body, so that the panel plate will completely match the core body;

(5) install and fasten the outside wooden line along the inside edge of the hollow-out section of the panel plate.

The connecting method of the panel plate and core body are cold pressing cohesion or hot pressing cohesion or gluing.

The invention has the beneficial effects as follows:

1. Compared with the traditional tenon joint, the exposed panel plate of this door is an integrated structure, therefore it is impossible that the paint on the panel plate cracks.

2. The number of sections and components that need to be processed are not plenty, the requirements for them low, the processing technology simple, and the requirements for the skills of the workers low. While the efficiency is high and the cost of manpower is low.

3. Foam material and shaving board can be used for the filling section of the core frame, because they insulate heat and absorb moisture, which could effectively prevent the core frame from distortion due to the variation of humidity and temperature.

4. When the panel plate is being manufactured, a certain amount of surplus should be preserved to ensure that the panel plate will totally match the core body.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is the schematic illustration of the core body, according to embodiment 1 of the present invention;

FIG. 2 is the schematic illustration of the panel plate, according to embodiment 1 of the present invention;

FIG. 3 is the schematic illustration, according to embodiment 2 of the present invention;

FIG. 4 is the schematic illustration, according to embodiment 3 of the present invention;

FIG. 5 is the section view of part of the core frame, according to embodiments 1-3 of the present invention;

FIG. 6 is the schematic illustration of the core body, according to embodiment 4 of the present invention;

FIG. 7 is the schematic illustration of the panel plate, according to embodiment 4 of the present invention;

FIG. 8 is the schematic illustration of the outside wooden line, according to embodiment 4 of the present invention;

FIG. 9 is the section view of part of the core frame, according to embodiments 4 of the present invention.

Hereinto: 1. core body, 2. panel plate, 3. core plate, 4. outside wooden line; 101. core frame, 102. hollow section, 103. left stile, 104. right stile, 105. top rail, 106. bottom rail, 107. rail, 108. stile, 109. outside frame, 110. inside frame, 111. filling section, 112. groove, 113. lock rail; 201. hollow-out section, 202. outside edge of the panel plate, 203. inside edge of the hollow out section.

The figures are not intended to be exhaustive or to limit the invention to the precise form disclosed. It should be understood that the invention can be practiced with modification and alteration, and that the invention be limited only by the claims and the equivalents thereof

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

### Embodiment 1

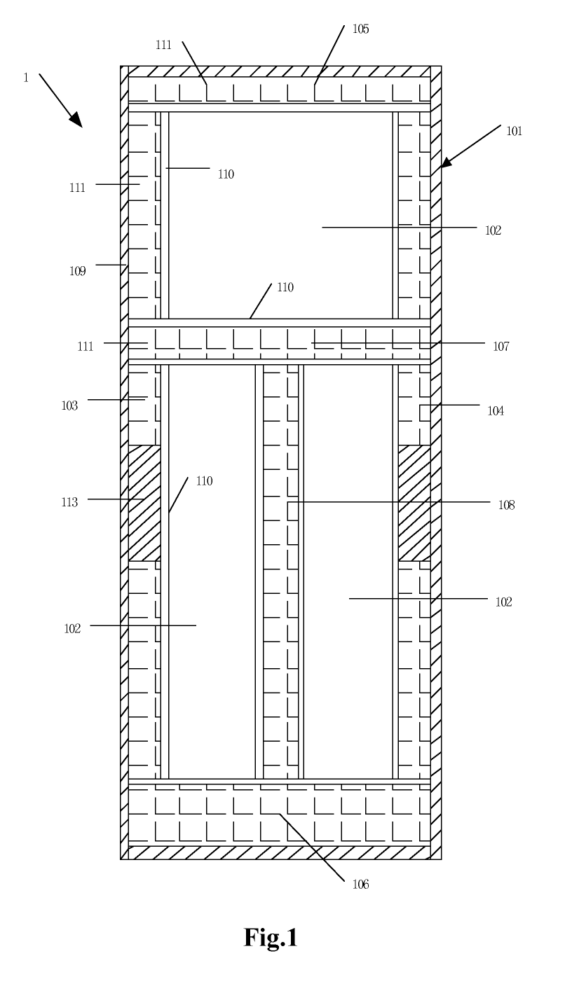

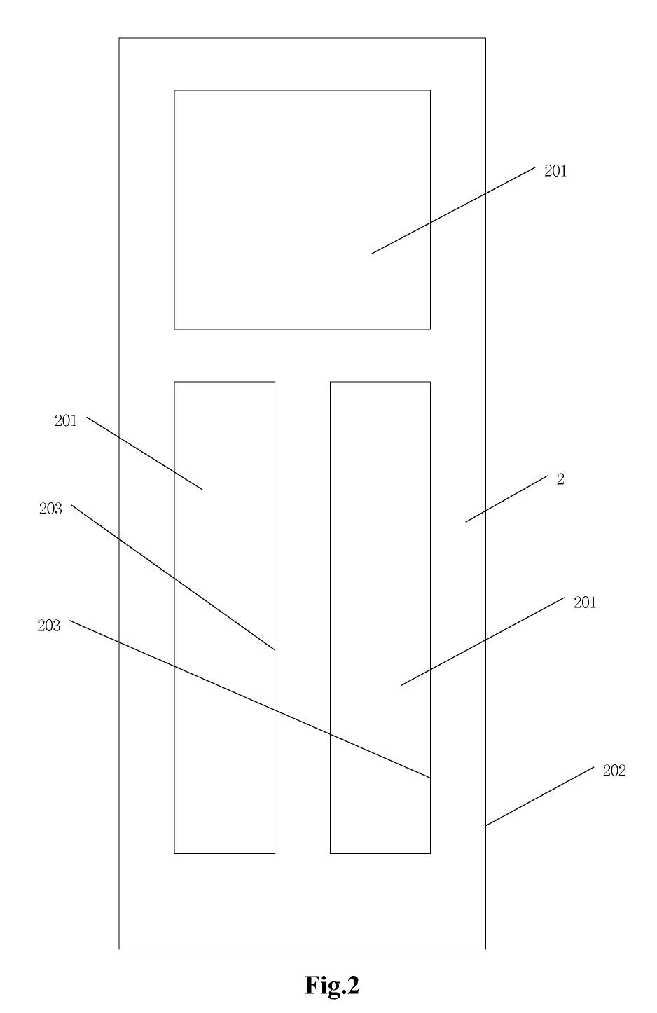

As shown in FIG. 1, FIG. 2 and FIG. 5, the invention comprises the core body 1, panel plate 2 and core plate 3. Core plate 3 includes core frame 102 and the hollow section 102 which enclosed by core frame 101. Core plate 3 is installed in the hollow section 102. There is hollow-out section 201 in the panel plate 2. The shape of panel plate 2 matches that of the core body 1, and the shape of hollow-out section 201 matches that of the hollow section 102. The hollow section 102 is a hollow out structure with a combination of a square and two rectangles. The core frame 101 comprises left stile 103, right stile 104, top rail 105, bottom rail 106, rail 107 and stile 108. Of which, all the structures of left stile 103, right stile 104, top rail 105, bottom rail 106, rail 107 and stile 108 include an outside frame 109 and an inside frame 110, and in the hollow section enclosed by outside frame 109 and inside frame 110 there is a filling section 111. The material used for filling section 111 is foaming material, that used for outside frame 109 is solid wood, and that used for inside frame 110 is also solid wood. In the inside frame 110 there is a groove 112, the width of which should match the thickness of core plate 3. Core plate 3 is inserted in the groove 112. The material of core plate 3 is MDF (medium density fiberboard). There is a lock rail 113 on the left stile 103 and/or right stile 104, and the lock rail 113 is used for installing the locks.

The manufacturing method of the crack-resistant composite wooden door mentioned above includes the following steps:

(1) produce the core frame 101, and insert the core plate 3 in the grooves 112 of the inside core frames 110;

(2) fasten and install the lock rail 113 in the hollow section of the left stile 103 and/or right stile 104 of the core frame 101. Then put the filling section 111 into the hollow structure formed by the outside frame 109 and inside frame 110 of the core frame 101;

(3) produce panel plate 2 according to the shape of the core body 1, leaving a surplus of 1-5 mm respectively at the outside edge 202 of plate 2 and the inside edge 203 of its hollow-out section 201;

(4) fasten and connect the panel plate 2 and the core body 1, and do the edge milling for the outside edge 202 of the panel plate 2 and the inside edge 203 of the hollow-out section 201 according to the sizes of the core body 1, so that panel plate 2 will completely match core body 1.

(5) install and fasten the outside wooden line 4 along the inside edge 203 of the hollow-out section 201 of the panel plate 2.

The connecting method of the panel plate 2 and core body 1 are cold pressing cohesion or hot pressing cohesion or gluing.

### Embodiment 2

Except for the differences listed as below, others are the same as the embodiment 1.

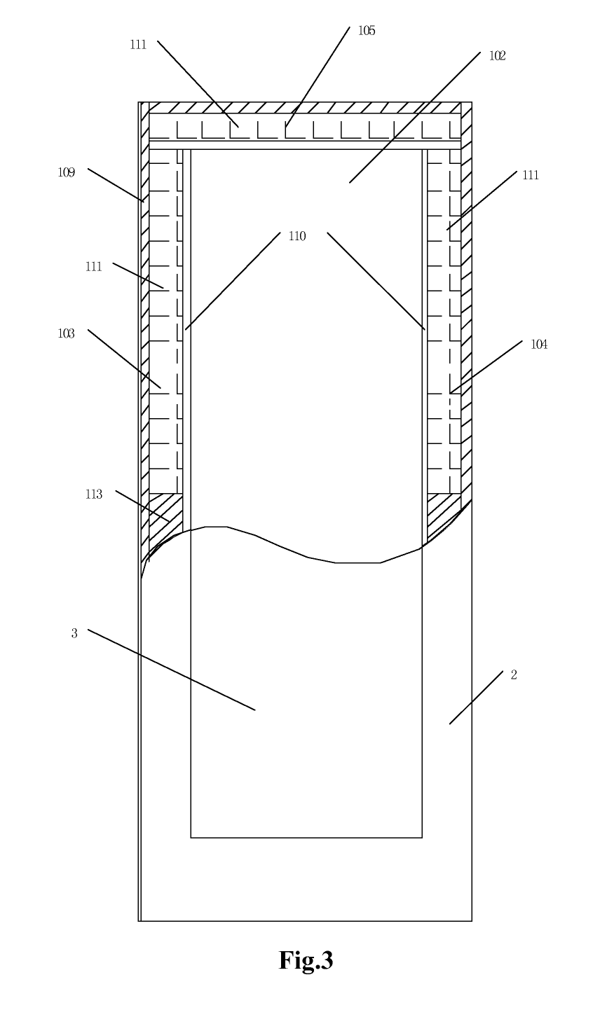

As shown in FIG. 3 and FIG. 5, the core frame 101 includes the left stile 103, right stile 104, top rail 105 and bottom rail 106. the hollow section 102 is a rectangular hollow out structure.

The filling material for filling section 111 is MDF, that for outside frame 109 is solid wood, and that for inside frame 110 is solid wood.

The material of core body 3 is MDF or glass.

### Embodiment 3

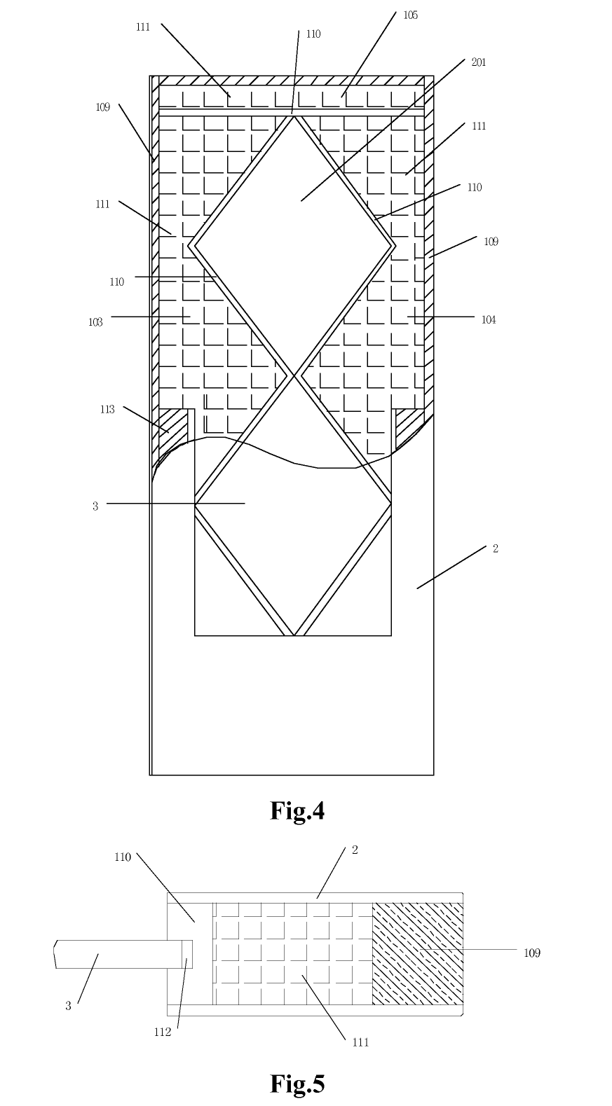

As shown in FIG. 4 and FIG. 5, the core frame 101 includes left stile 103, right stile 104, top rail 105 and bottom rail 106. Of which, left stile 103 and right stile 104 are of anomalous structure. The hollow section 102 is a hollow out structure of the combination of two diamonds.

The material for the filling section 111 is shaving board, that for outside frame 109 is solid wood and that for inside frame 110 is solid wood.

The material for core plate 3 is glass.

### Embodiment 4

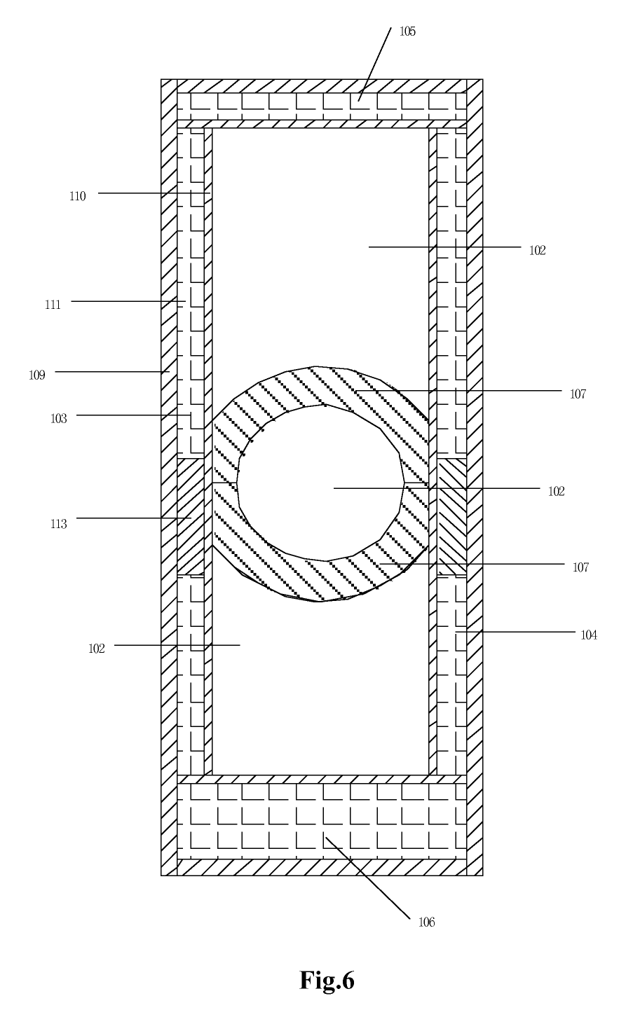

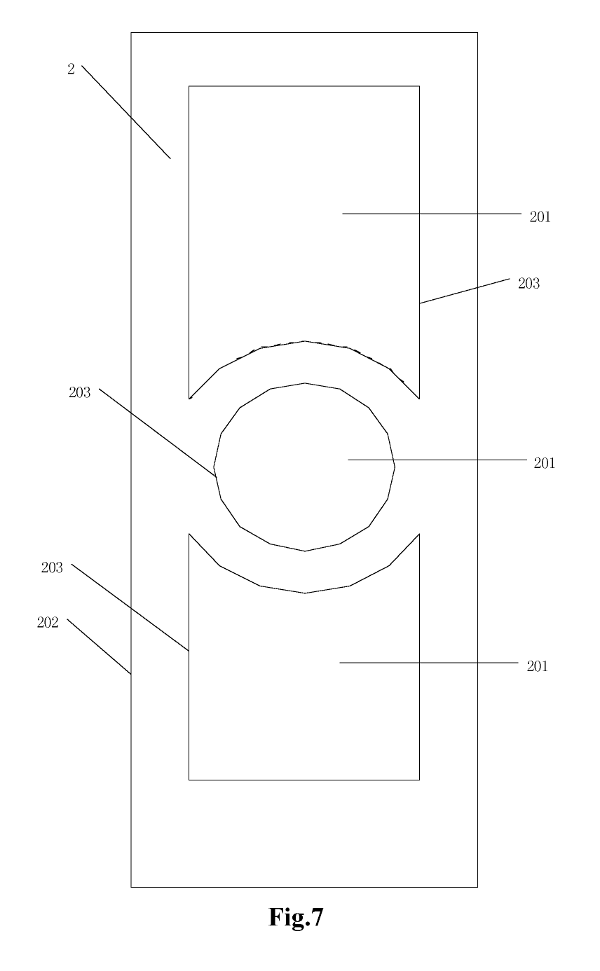

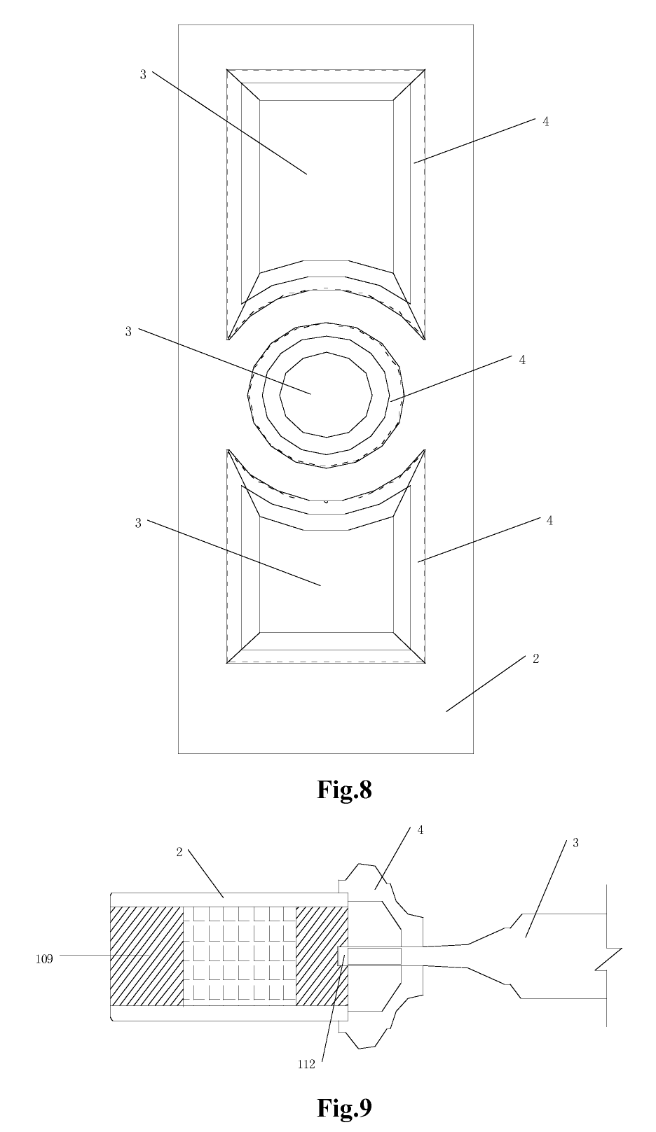

As shown in FIG. 6-FIG. 95, the invention comprises the core body 1, panel plate 2, core plate 3 and outside wooden line 4. Core plate 3 includes core frame 102 and the hollow section 102 enclosed by core frame 101. Core plate 3 is installed in the hollow section 102. There is hollow-out section 201 in the panel plate 2. The shape of panel plate 2 matches that of the core body 1, and the shape of hollow-out section 201 matches that of the hollow section 102. The hollow section 102 is a hollow out structure with a combination of two rectangles with circular arcs and circles. The core frame 101 comprises left stile 103, right stile 104, top rail 105, bottom rail 106 and rail 107. Of which, rail 107 is half an axisymmetric circular structure. And of which, all the structures of left stile 103, right stile 104, top rail 105, bottom rail 106, rail 107 include an outside frame 109 and an inside frame 110, and in the hollow section enclosed by outside frame 109 and inside frame 110 there is a filling section 111. The material used for filling section 111 is solid wood, that used for outside frame 109 is solid wood, and that used for inside frame 110 is also solid wood. In the inside frame 110 there is a groove 112, the width of which should match the thickness of core plate 3. Core plate 3 is inserted in the groove 112. The material of core plate 3 is MDF (medium density fiberboard). There is a lock rail 113 on the left stile 103 and/or right stile 104, and the lock rail 113 is used for installing the locks. The material for outside wooden line 4 is high molecular material.

The manufacturing method of the crack-resistant composite wooden door mentioned above includes the following steps:

(1) produce the core frame 101, and insert the core plate 3 in the grooves 112 of the inside core frames 110;

(2) fasten and install the lock rail 113 in the hollow section of the left stile 103 and/or right stile 104 of the core frame 101. Then put the filling section 111 into the hollow structure formed by the outside frame 109 and inside frame 110 of the core frame 101;

(3) produce panel plate 2 according to the shape of the core body 1, leaving a surplus of 1-5 mm respectively at the outside edge 202 of plate 2 and the inside edge 203 of its hollow-out section 201;

(4) fasten and connect the panel plate 2 and the core body 1, and do the edge milling for the outside edge 202 of the panel plate 2 and the inside edge 203 of the hollow-out section 201 according to the sizes of the core body 1, so that panel plate 2 will completely match core body 1.

(5) install and fasten the outside wooden line 4 along the inside edge 203 of the hollow-out section 201 of the panel plate 2.

The connecting method of the panel plate 2 and core body 1 are cold pressing cohesion or hot pressing cohesion or gluing.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open United as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A crack-resistant composite wooden door, comprising:
1) core body(1);
It comprising:
(a). core frame (101);
(b). the hollow section (102) which enclosed by the core frame (101).
2) panel plate (2);
It comprising hollow-out section (201).
3) core plate (3);
The core plate (3) is installed in the hollow section (102). The shape of panel plate (2) matches that of the core body (1), and the shape of hollow-out section (201) matches that of the hollow section (102).

2. A crack-resistant composite wooden door of claim 1, wherein the base further comprises:
The hollow section (102) mentioned is a hollow out structure of the combinations of one or more triangle, rectangle, square, fillet rectangle or circle.

3. A crack-resistant composite wooden door of claim 1, wherein the base further comprises:
The core frame (101) mentioned comprises left stile (103), right stile (104), top rail (105) and bottom rail (106).

4. A crack-resistant composite wooden door of claim 3, wherein the base further comprises:
The core frame (101) mentioned includes rail (107) and/or stile (108).

5. A crack-resistant composite wooden door of claim 1, wherein the base further comprises:
The core frame (101) mentioned includes outside frame (109) and inside frame (110), and in the hollow section enclosed by outside frame (109) and inside frame (110) there is a filling section (111).

6. A crack-resistant composite wooden door of claim 5, wherein the base further comprises:
The inside frame (110) comprising a groove (112), the width of the groove should match the thickness of core plate (3). Core plate (3) is inserted in the groove (112).

7. A crack-resistant composite wooden door of claim 6, wherein the base further comprises:
An outside wooden line (4); and the outside wooden line (4) is designed along the inside edge (203) of the hollow-out section (201).

8. A manufacturing method of the crack-resistant composite wooden door, which comprises the following steps:
1) producing the core frame (101), and inserting the core plate (3) in the grooves (112) of the inside core frame (110) of the core frame (101);
2) fastening and installing the lock rail (113) in the hollow section of the left stile (103) and/or right stile (104) of the core frame (101). Then putting the filling section (111) into the hollow structure formed by the outside frame (109) and inside frame (110) of the core frame (101);
3) producing panel plate (2) according to the shape of the core body (1), leaving a surplus of 1-5 mm respectively at the outside edge (202) of plate (2) and the inside edge (203) of it's hollow-out section (201);
4) fastening and connecting the panel plate (2) and the core body (1), and doing the edge milling for the outside edges (202) of the panel plate (2) and the inside edge (203) of the hollow-out section (201) according to the sizes of the core body (1), so that the panel plate (2) will completely match the core body (1);
The crack-resistant composite wooden door mentioned comprising:
1) core body(l);
It comprising:
(a). core frame (101);
(b). the hollow section (102) which enclosed by the core frame (101).
2) panel plate (2);
It comprising hollow-out section (201).
3) core plate (3);
The core plate (3) is installed in the hollow section (102). The shape of panel plate (2) matches that of the core body (1), and the shape of hollow-out section (201) matches that of the hollow section (102);
The core frame (101) mentioned comprises left stile (103), right stile (104), top rail (105), bottom rail (106);
The core frame (101) mentioned includes an outside frame (109) and an inside frame (110), and in the hollow section which enclosed by outside frame (109) and inside frame (110) there is a filling section (111);
The inside frame (110) comprising a groove (112), the width of the groove should match the thickness of core plate (3). Core plate (3) is inserted in the groove (112).

9. A manufacturing method of this crack-resistant composite wooden door, which includes the following steps:
1) producing the core frame (101), and inserting the core plate (3) in the grooves (112) of the inside core frame (110) of the core frame (101);
2) fastening and installing the lock rail (113) in the hollow section of the left stile (103) and/or right stile (104) of the core frame (101). Then putting the filling section (111) into the hollow structure formed by the outside frame (109) and inside frame (110) of the core frame (101);
3) producing panel plate (2) according to the shape of the core body (1), leaving a surplus of 1-5 mm respectively at the outside edge (202) of panel plate (2) and the inside edge (203) of its hollow-out section (201);
4) fastening and connecting the panel plate (2) and the core body (1), and doing the edge milling for the outside edges (202) of the panel plate (2) and the inside edge (203) of the hollow-out section (201) according to the sizes of the core body (1), so that the panel plate (2) will completely match the core body (1);
5) installing and fastening the outside wooden line (4) along the inside edge (203) of the hollow-out section (201) of the panel plate (2).
The crack-resistant composite wooden door mentioned comprising:
1) core body(l);
It comprising:
(a). core frame (101);
(b). the hollow section (102) which enclosed by the core frame (101).
2) panel plate (2);
It comprising hollow-out section (201).
3) core plate (3);
The core plate (3) is installed in the hollow section (102). The shape of panel plate (2) matches that of the core body (1), and the shape of hollow-out section (201) matches that of the hollow section (102);
4) outside wooden line (4);
it is designed along the inside edge (203) of the hollow-out section (201);
The core frame (101) mentioned comprises left stile (103), right stile (104), top rail (105), bottom rail (106);
The core frame (101) mentioned includes an outside frame (109) and an inside frame (110), and in the hollow section which enclosed by outside frame (109) and inside frame (110) there is a filling section (111);
The inside frame (110) comprising a groove (112), the width of the groove should match the thickness of core plate (3). Core plate (3) is inserted in the groove (112).
